(19) United States
(12) Patent Application Publication
(10) Pub. No.: US 2015/0068947 A1
(43) Pub. Date: Mar. 12, 2015

(54) MEDICINE DISPENSER WITH BUILT-IN DISPENSING SCHEDULE

(71) Applicant: RedCap, LLC, Marblehead, MA (US)

(72) Inventors: Alfred Richard Balakier, Kirkland, WA (US); Daniel Albert Gosselin, Gloucester, MA (US)

(73) Assignee: RedCap, LLC, Marblehead, MA (US)

(21) Appl. No.: 14/275,809

(22) Filed: May 12, 2014

Related U.S. Application Data
(63) Continuation-in-part of application No. 13/110,870, filed on May 18, 2011, now Pat. No. 8,857,617.
(60) Provisional application No. 61/395,939, filed on May 18, 2010.

(51) Int. Cl. A61J 7/04

(52) U.S. Cl. CPC A61J 7/0409; A61J 2007/0436
USPC 206/534

(57) ABSTRACT

The current disclosure is directed to a medicine dispenser with a dispensing schedule. In one implementation, the medicine dispenser includes a cylindrical container and a disk-shaped cap having a cylindrical rim and an inner schedule display. An indication on or within the inner schedule display is displayed to a medicine consumer through an aperture in the cylindrical rim of the cap. Features included in the cap, schedule display, and cylindrical container interoperate to ensure that the displayed indication is advanced when the cap is removed from, and subsequently replaced on, the container. The displayed indication is relatively large and clear, to facilitate viewing by vision-impaired users, and the schedule-advancement mechanism is robust and reliable. In addition, the cap and inner schedule display include features that allow the displayed indication to be set to a particular indication.

### CROSS-REFERENCE TO RELATED APPLICATIONS

This application is a continuation-in-part of application Ser. No. 13/110,870, filed May 18, 2011, which claims the benefit of Provisional Patent Application No. 61/395,939, filed May 18, 2010 and Provisional Patent Application No. ______ filed May 10, 2013.

### TECHNICAL FIELD

The current disclosure is related to medicine dispensers, including pill bottles, and, in particular, to a medicine dispenser that includes a mechanical dispensing schedule that indicates when a next dose is to be administered.

### BACKGROUND

Failure to adhere to a prescribed medication-dosage regimen is a dangerous and ubiquitous problem. Missing a prescribed dosage of certain medications, such as blood-pressure medicine, may result in significant harm and even death. Accidental overdose of prescription medication often causes negative effects that are even more dangerous and immediate than missing a prescribed dosage.

According to the National Council on Patient Information, up to 60% of all prescribed medication is taken incorrectly. Physicians take only 75% of prescribed pills correctly. Non-compliance costs more than $300 billion a year in the USA, accounts for 13% of all hospital admissions, and causes 300,000 deaths.

In addition to prescribed medication, there are vitamins and other supplements that do not require a prescription from a doctor and that are also recommended for use according to a regular schedule. Failure to adhere to a recommended schedule may lessen the effectiveness of the vitamins and other supplements and may exposes a consumer to the risk of overdose. Pills prescribed by veterinarians for the care of animals are associated with similar risks and consequences when not used according to a prescribed dosing schedule.

Trying to determine whether or not a particular dose has already been taken or administered is, for many, an even more difficult aspect of adhering to a recommended administration schedule than remembering the times of scheduled doses. The repetitive nature of consuming pills on a daily basis can lead to confusion with regard to whether or not a particular dose that were scheduled for administration have, in fact, been administered.

Many different medicine dispensers and medicine-dispensing regimes have been proposed and developed in order to assist consumers in self-administration of drugs, vitamins, and other consumables. However, the fact that, according to current statistics, non-compliance with administration schedules continues to be a serious problem and represents a significant financial burden to consumers as well as to society, as a whole, indicates that the many proposed and currently-available regimes and dispensers have not effectively addressed problems associated with self-administration of pills by consumers.

### SUMMARY

The current disclosure is directed to a medicine dispenser with a dispensing schedule. In one implementation, the medicine dispenser includes a cylindrical container and a disk-shaped cap having a cylindrical rim and an inner schedule display. An indication on or within the inner schedule display is displayed to a medicine consumer through an aperture in the cylindrical rim of the cap. Features included in the cap, schedule display, and cylindrical container interoperate to ensure that the displayed indication is advanced when the cap is removed from, and subsequently replaced on, the container. The displayed indication is relatively large and clear, to facilitate viewing by vision-impaired users, and the schedule-advancement mechanism is robust and reliable. In addition, the cap and inner schedule display include features that allow the displayed indication to be set to a particular indication.

### BRIEF DESCRIPTION OF THE DRAWINGS

FIG. 1 shows a perspective view of a first implementation of the medicine dispenser to which the current disclosure is directed.

FIG. 2 shows an enlarged exploded perspective of the first implementation shown in FIG. 1.

FIG. 3 shows a top plan view of the implementation shown in FIG. 1.

FIG. 4 shows a perspective view of the cap of the implementation shown in FIG. 1.

FIG. 5 shows a perspective view of the schedule display from the implementation shown in FIG. 1.

FIG. 6 shows a perspective view of the cap assembly of the implementation shown in FIG. 1.

FIG. 7 shows a cross-section of a portion of the implementation shown in FIG. 1.

FIG. 8 shows an enlarged unwrapped view of a portion of the cap ratchet wheel and the schedule-display ratchet wheel of the implementation shown in FIG. 1.

FIGS. 9A-H provide unwrapped views of cap, schedule-display, and cylindrical container components of the implementation shown in FIG. 1 that illustrate step-by-step interaction of these components as the cap is mounted onto and removed from the pill bottle.

FIG. 10 shows an enlarged unwrapped view of an alternative implementation of the cap ratchet wheel and schedule-display ratchet wheel.

FIGS. 11A-D illustrate a second example implementation of the medicine dispenser.

FIG. 12 shows a cross-section view of the second implementation shown in FIGS. 11A-D.

FIG. 13 shows an enlarged unwrapped view of a portion of the cap ratchet wheel and the schedule-display ratchet wheel of the second implementation shown in FIGS. 11A-D.

FIGS. 14 A-I provide unwrapped views of cap, schedule-display, and container components of the second implementation shown in FIGS. 11A-D that illustrate step-by-step interaction of these components as the cap is mounted onto, and removed from, the pill bottle.

FIGS. 15 A-I provide unwrapped views of cap, schedule display, and bottle components of a third implementation that illustrate step-by-step interaction of various components as the cap is mounted onto, and removed from, the pill bottle.

FIGS. 16A-J provide unwrapped views of cap, schedule display, and bottle components of a fourth implementation that illustrate step-by-step interaction of various components and features as the cap is removed from, and remounted onto, the pill bottle.

FIGS. 17A-C illustrate a fifth implementation of the medicine dispenser to which the current disclosure is directed.

FIG. 18 illustrates a method of using a machine-readable code to improve pharmacy safety.

### DETAILED DESCRIPTION

The current disclosure is directed to medicine dispensers, including pill-bottle-like medicine dispensers, that feature secure child-resistant containment of medicines within the medicine dispenser as well as a robust and reliable mechanism for display of an indication of the time and day when a next dose needs to be administered to, or self-administered by, a medicine consumer, such as a patient in a healthcare facility or an outpatient. Unlike currently-available medicine dispensers and medication-dispensing regimes, the medicine dispensers to which the current disclosure is directed feature relatively large, easy-to-read indications for time and day of next administration of a dose from the medicine dispenser as well as reliable advancement of the displayed indication within the medicine-dispensing schedule. In addition, the dispensing schedule can be initially set to an arbitrary one of the multiple indications included in the dispensing schedule.

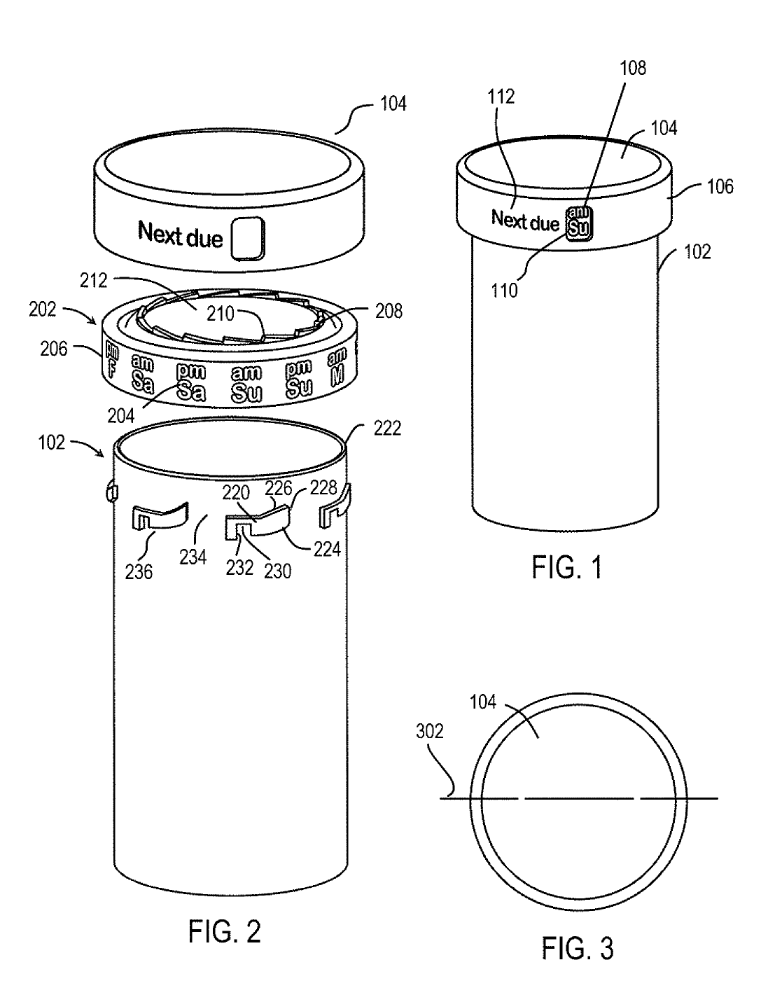

FIG. 1 shows a perspective view of a first implementation of the medicine dispenser to which the current disclosure is directed. The illustrated implementation includes a cylindrical container 102 and a disk-shaped cap 104, the plane of which is orthogonal to the long axis of the cylindrical container 102 when mounted onto the cylindrical container. The cap includes a cylindrical rim 106 of larger inner diameter than the diameter of the cylindrical container 102. A schedule-display component, discussed below, is mounted within the cap to form a cap-and-schedule-display assembly, or indicating cap. A single indication, or schedule element 108, is displayed to a user through a rectangular aperture 110 in the cylindrical cap rim 106. In the example implementation shown in FIG. 1, the schedule element includes an indication of the time of day, “am,” and an indication of the day of the week, “Su,” when a next dose is to be administered to, or self-administered by, a medicine consumer. In the example shown in FIG. 1, the label “Next due” 112 is imprinted on the cap rim 106 as a further indication that the displayed indications of a time and day of the week indicate a next time and day when a next dose is to be administered to, or self-administered by, the medicine consumer.

Interior features of the cap, inner schedule display, and container interoperate to ensure that displayed indication is advanced by one element with respect to the schedule display when the cap is removed and remounted onto the container. The display indication is not advanced with respect to the schedule display unless the cap is successfully removed and replaced. Unlike in many currently-available devices, the displayed indication is displayed from the cap rim, ensuring that there is adequate available area to display a clear and easily read indication. The particular form of the indications for when a next dose is to be administered or self-administered may vary with different implementations of the medicine dispenser. In certain cases, the indication may include a particular hour and day of the week. In alternative implementations, the indication may only display a day of the week. In yet further implementations, the indication may display precise time and/or date information. The schedule display may include an essentially arbitrary number of different elements, or indications. In the example implementation discussed with reference to FIG. 1, the schedule display includes 14 schedule elements that include morning and evening administration times for each of the seven days of the week.

The medicine container and dispenser shown in FIG. 1 can be inexpensively manufactured from commonly used polymeric materials. When manufactured according to currently-available precision, the three interoperating components of the example medicine-dispenser implementation provide for reliable advancement of the displayed schedule elements by one position only when the cap is successfully removed and remounted onto the cylindrical container. Implementations of the medicine dispenser are designed for rapid, reliable, and cost-efficient mass-manufacturing. Each of the three single-piece components, including the cap 104, schedule display 202, and cylindrical container 102 is shaped so that it can be quickly released from a mold. A single-piece component is a component that can be directly manufactured, without subsequent assembly from multiple subcomponents, such as a plastic object that is injection molded or a stamped, continuous metal object.

FIG. 2 shows an enlarged exploded perspective of the implementation shown in FIG. 1. In the exploded view, the three components of the example medicine-dispenser implementation shown in FIG. 1 are clearly visible, as well as additional features of two of the three components. The cylindrical, schedule display 202 is shown disassembled from, and below, the cap 104. As can be more clearly seen in FIG. 2, the schedule display includes 14 time-of-day and day-of-week elements or indications, such as the “pm/Sa” indication 204 from among 6 of the 14 schedule elements, or indications, visible along the outer cylindrical wall, or display surface, 206 of the schedule display. The schedule display also includes a schedule-display ratchet wheel 208 with ratchet teeth, such as ratchet tooth 210, and a disk-like surface 212 orthogonal to the axis of the cylindrical wall 206. On the outer surface of the cylindrical container 102, seven boss features, including boss feature 220, extend outward from the outer surface of the cylindrical container. The boss features are uniformly spaced along the circumference of the cylinder positioned at a uniform position with respect to the lip 222 of the cylindrical container 102. Each boss feature includes a cam surface 224, a ramp portion 226, a leading edge 228, a lug notch 230, and a stop portion 232. There is a significant space between each pair of boss features along the circumference of the cylinder, such as space 234 between boss 220 and preceding boss 236.

FIG. 3 shows a top plan view of the implementation shown in FIG. 1. As can be seen in FIG. 3, the cap is circular in a projection orthogonal to the plane of the disk-shaped cap. Line 302 in FIG. 3 indicates the intersection of a plane orthogonal to the disk-shaped surface of the cap with the cap that defines a cross-section view of the example medicine-dispenser implementation shown in FIG. 7.

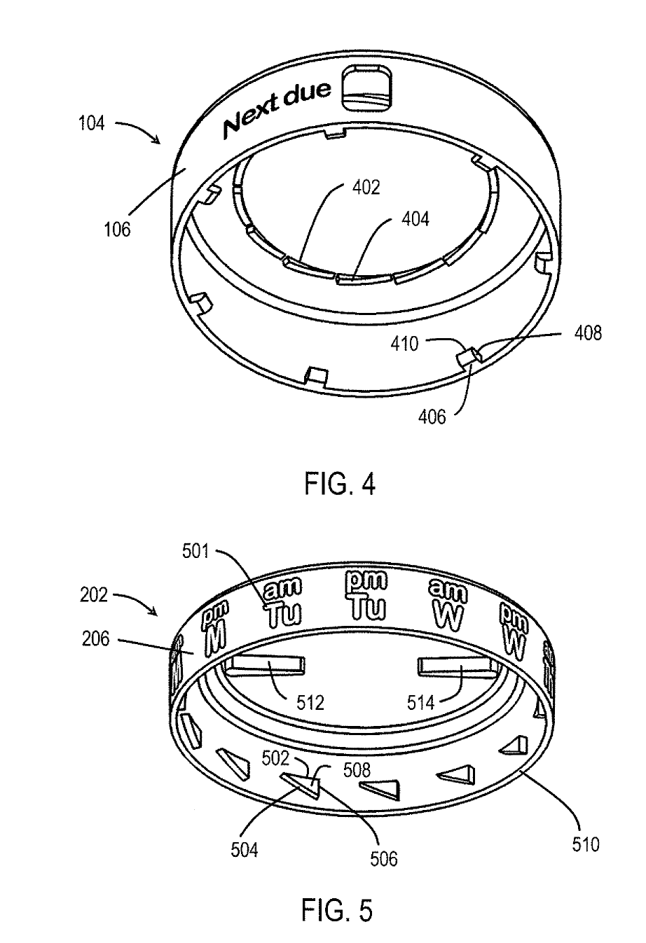

FIG. 4 shows a perspective view of the cap of the implementation shown in FIG. 1. In FIG. 4, the cap component is viewed from below. As can be seen in FIG. 4, the cap includes a cap ratchet wheel 402 with ratchet teeth, such as ratchet tooth 404 that protrude downward, orthogonal to the plane of the disk-shaped cap and parallel to the cylindrical cap rim 106. The cap ratchet wheel is complementary to the schedule-display ratchet wheel (208 in FIG. 2). At the base of the cap rim, seven lugs, such as lug 406, uniformly spaced along the bottom edge of the cap rim, protrude inward in radial directions from the inner surface of the cap rim. Each lug features a leading edge 408 and an inside edge 410. In the example implementation shown in FIGS. 1-4, there are seven uniformly spaced lugs complementary to the spacings between the seven boss features (220 and 236 in FIG. 2) of the cylindrical container 102. There are 14 ratchet teeth in both the cap ratchet wheel 402 and the schedule-display ratchet wheel (208 in FIG. 2). These various features interoperate, together with the features described below, to provide both child-resistant locking of the cap to the cylindrical container as well as to provide for reliable advancement of the displayed schedule element by one element with each successful removal and replacement of the cap.

FIG. 5 shows a perspective view of the schedule display from the implementation shown in FIG. 1. In FIG. 5, the schedule display 202 is shown from underneath. In addition to the schedule elements uniformly spaced on the display surface of the schedule display 206, such as schedule element 204, the schedule display additionally includes 14 triangular biasing features, such as biasing feature 502, that extend inward, in radial directions, from the inner surface of the cylindrical wall of the schedule display. Each biasing feature includes a lower sliding surface 504, an abutment surface 506, and an inner side 508. As discussed below, the biasing features interoperate with the boss features (220 and 236 in FIG. 2) that extend from the outer surface of the cylindrical container 102 in order to facilitate advancement of the displayed schedule element upon successful removal and replacement of the cap onto the cylindrical container. In the example medicine-dispenser implementation of the medicine dispenser illustrated in FIGS. 1-5, there are 14 biasing features positioned uniformly along the inner circumference of the schedule display at uniform positions with respect to the lower edge 510 of the schedule display. In addition, the schedule display includes two grips 512 and 514 that extend downward from the inner surface of the disk-shaped top portion (212 in FIG. 2) of the schedule display. These two grips allow for initial positioning of a particular schedule element below the display aperture (110 in FIG. 1) of the cap rim to provide an initial administration-time indication for administration of a first dose.

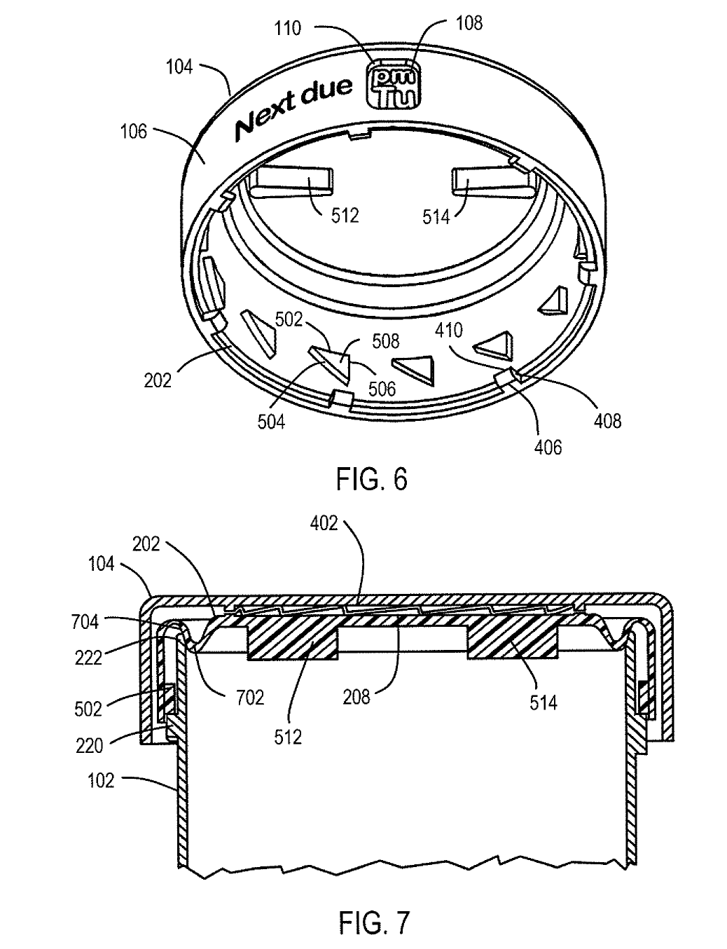

FIG. 6 shows a perspective view of the cap assembly of the implementation shown in FIG. 1. In FIG. 6, the schedule display 202 is shown inserted into the cap 104 to produce a fully assembled cap with schedule display. Note that the schedule display is pushed into the cap past the seven lugs, such as lug 406, which snap the schedule display into position and hold the schedule display within the cap. Note also that the schedule display is rotatably mounted within the cap, although the cap ratchet wheel (402 in FIG. 4) and schedule-display ratchet wheels are partially engaged, when the cap is not mounted onto the container, and this partial engagement prevents the schedule display from freely rotating within the cap, but allows the schedule display to be rotated in order to select a particular schedule element for display through the cap aperture (110 in FIG. 1) by applying a rotational force to grips 512 and 514. As discussed below, when the cap is mounted onto the cylindrical container, features of the schedule display, discussed below, apply pressure to the schedule-display ratchet wheel to fully mesh the schedule-display ratchet wheel together with the cap ratchet wheel to prevent rotation of the schedule display with respect to the cap. Thus, in general, the schedule display remains in a fixed position with respect to the cap, whether or not the cap is fastened to the container, but is relatively loosely held in position, when the cap is not mounted onto the container, allowing the schedule display to be manually rotated with respect to the cap in order to select a particular schedule element for display by applying pressure to grips 512 and 514.

While the example medicine dispenser shown in FIGS. 1-6 includes 14 ratchet teeth on each ratchet wheel, seven lugs, seven boss features, and 14 biasing features, the number of these features may be altered, in alternative implementations, in order to provide for a different number of schedule elements. In these alternative implementations, the ratio of two biasing features to one boss feature is preserved in order to facilitate advancement of the displayed schedule element by one element when the cap is removed from and remounted onto the container. However, in yet additional implementations, this ratio may also be altered.

FIG. 7 shows a cross-section of a portion of the implementation shown in FIG. 1. As mentioned above, FIG. 7 shows a cross-section view of the medicine-dispenser implementation shown in FIGS. 1-6 with respect to a plane that intersects the cap along line 302 in FIG. 3. FIG. 7 includes numeric labels used above, in FIGS. 1-2 and 4-6. The cross-sectional view shown in FIG. 7 illustrates the medicine-dispenser implementation when the cap is firmly attached to the container. FIG. 7 reveals an additional feature of the schedule display. As shown in cross-section, the schedule display features an inner rim 702 with a wedge surface 704 against which the upper edge, or lip, of the cylindrical container (222 in FIG. 2) presses when the cap is mounted onto the cylindrical container. The pressure applied by the cylindrical container to the wedge surface 704 of the inner rim 702 forces the schedule-display ratchet wheel 208 upward to fully mesh together with the complementary cap ratchet wheel 402, locking the position of the schedule display with respect to the cap as well as providing an air-tight, gasket-like seal to provide air-tight containment of medicine within the cylindrical container. When the cap is mounted onto the cylindrical container, as discussed further below, each lug (406 in FIG. 4) is locked within the lug notch (230 in FIG. 2) of a boss feature (220 and 236 in FIG. 2). The cap isolates the contents of the container from the environment external to the container, preventing exchange of air, water vapor, liquids, and solids between the contents of the closed container and the environment external to the container.

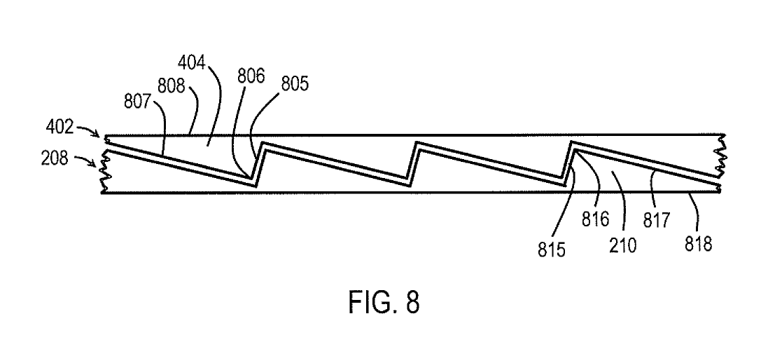

FIG. 8 shows an enlarged unwrapped view of a portion of the cap ratchet wheel and the schedule-display ratchet wheel of the implementation shown in FIG. 1. FIG. 8 illustrates how the cap ratchet wheel meshes together with the schedule-display ratchet wheel. As shown in FIG. 8, the cap ratchet wheel 402 includes a series of 14 teeth, such as tooth 804. The teeth protrude from a cap ratchet-wheel base 808. Each tooth includes an engaging side 805, a tip 806, and a sliding side 807. Similarly, the schedule-display ratchet wheel 208 includes a series of 14 teeth, such as tooth 814, each of which also includes an engaging side 815, a tip 816, and a sliding side 817, with the teeth disposed along a schedule-display ratchet-wheel base 818.

Mounting the cap-and-schedule-display assembly to, and removing the cap-and-schedule-display assembly from, the cylindrical container 102 is similar to mounting caps to, and removing caps from, commonly-available child-resistant pill bottles. First, cap 104 is placed onto the cylindrical container 102. Then, pressure is applied to cap 104 and cap 104 is rotated clockwise. Lugs 406 slide into spaces 234 between boss features 220 and 236. Each lug 406 encounters and slides around the cam surface 224 of one of the boss features 220. Sliding of the lugs 406 around the cam surfaces 224 draws the cap 104 onto the cylindrical container 102 and compresses the schedule display 202. Inner rim 702 of the schedule display 202 provides flexibility, enabling the schedule display to compress vertically. As the cap 104 draws onto cylindrical container 102, the wedge surface 704 of the inner rim 702 presses into the lip 222 of the cylindrical container to provide an airtight seal. When the lugs 406 reach the stop portion 232 of boss features 220, the cap 104 can no longer rotate. Compression of the schedule display 202 pulls lugs 406 up into lug notches 230. The cap 104 is now mounted onto cylindrical container 102.

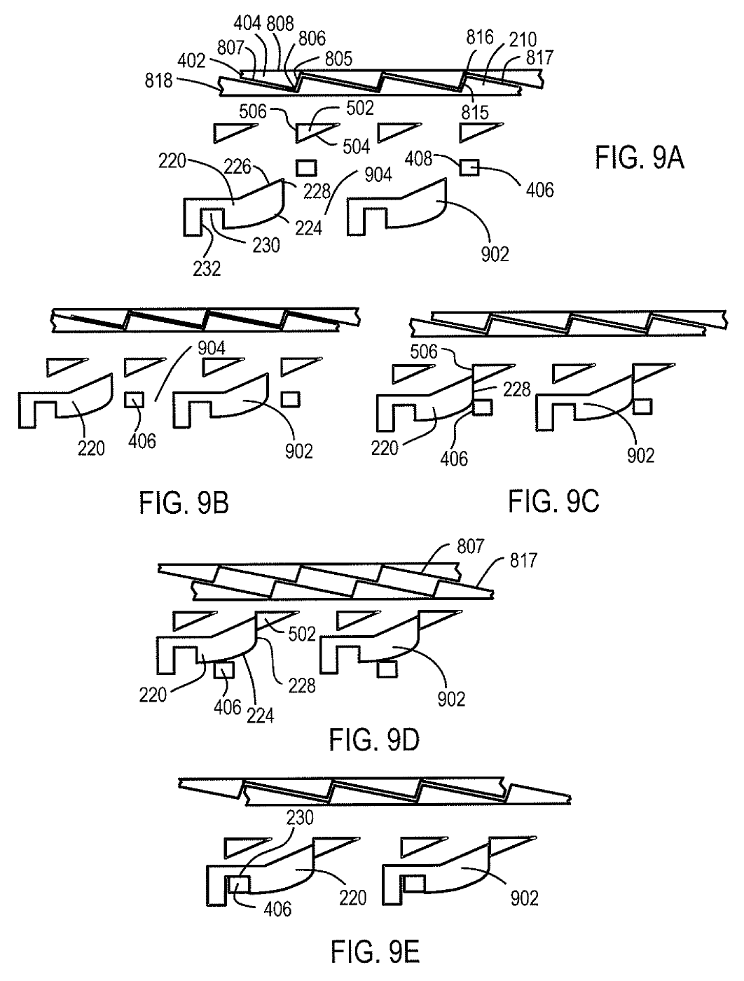

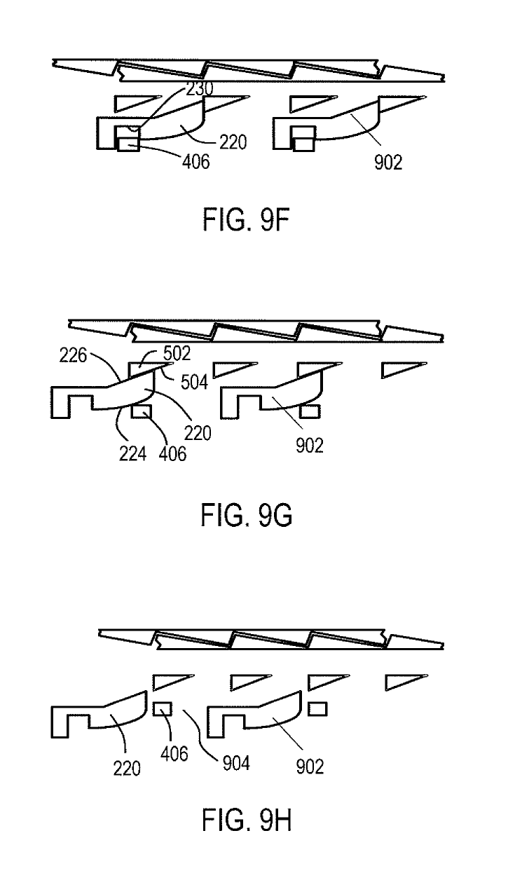

FIGS. 9A-H provide unwrapped views of cap, schedule display, and cylindrical container components of the implementation shown in FIG. 1 that illustrate step-by-step interaction of these components as the cap is mounted onto and removed from the container. FIGS. 9A-E illustrate the process of mounting the cap to the cylindrical container and the interaction of the various features and components during this process. As shown in FIG. 9A, prior to mounting the cap onto the container, the cap ratchet wheel 402 and schedule-display ratchet wheel 208 are meshed together at least partially, fixing the position of the schedule display with respect to the cap. Moreover, the leading edge 408 of each lug 406 is aligned with an abutment surface 506 of a biasing feature. This alignment is imposed by the meshing of the cap ratchet wheel with the schedule-display ratchet wheel, the fixed positions of the lugs with respect to the cap ratchet wheel, and the fixed positions of the biasing features with respect to the schedule-display ratchet wheel. When the cap is placed onto the cylindrical container and rotationally adjusted as the cap is forced down, the lugs 406 slip into the spaces 905 between boss features 220 and 902. Note that, during this process, meshing together of the cap ratchet wheel with the schedule-display ratchet wheel ensures that the schedule display turns with the cap and remains in a fixed position relative to the cap. Next, as shown in FIG. 9C, when the cap is rotated in a clockwise direction, the abutment surface 506 and leading edge 408 of each aligned pair of biasing features and lugs comes into contact with the leading edge 228 of a boss feature 236. As shown in FIG. 9D, as the cap continues to be rotated in a clockwise position, the biasing features 502 are prevented from rotating along with the cap by the leading edge 228 of the boss features with which they contact while the lugs 406 extending from the cap continue rotating along with the cap in a clockwise direction along the cam surface 224 of the boss feature. Because the rotation of the schedule display is prevented while the cap continues to rotate, the sliding sides of the teeth of the cap ratchet wheel slide on the sliding sides 817 of the teeth of the schedule-display ratchet wheel as the cap rotates with respect to the schedule display. Flexibility in schedule display 202 provided by inner rim 702 allows schedule display 202 to compress so that cap ratchet wheel 402 and schedule-display ratchet wheel 208 can slip over each other in the disengaged direction. As cap 104 rotates around schedule display 202, aperture 110 moves from one schedule element 204 to the next. In the example implementation leading edges 228 are a flat abutment surface. In practice, cam surfaces 224 can be extended upwards to the top of ramp portion 226 thereby shortening leading edges 228 so that they are a shorter flat vertical surface or are pointed. Finally, as shown in FIG. 9E, the lugs 406 slip into the lug notches 230 of the boss features 220 and 902 as the teeth of the cap ratchet wheel interlock again with the teeth of the cap ratchet wheel advanced clockwise by one tooth with respect to the schedule-display ratchet wheel. Thus, attaching the cap to the cylindrical container results in advancement of the displayed schedule element by one element along the sequence of schedule elements disposed along the circumference of the cylindrical schedule-display rim.

FIGS. 9F-H illustrate components and features of the medicine-dispenser implementation discussed with reference to FIGS. 1-9E as the cap is removed from the container. As shown in FIG. 9F, to remove the cap, a user initially pushes down on the cap, forcing the lugs 406 to disengage from the lug notches 230 of the boss features 220 and 902. Next, as shown in FIG. 9G, the cap is rotated in a counter-clockwise direction, with each lug 406 traveling along the cam surface 224 of each boss feature 220 and 902 while the sliding surface 504 of each biasing feature 502 slides along the ramp portion 226 of the boss feature. As biasing features 502 slide over ramp portions 226, the schedule display 202 is pushed upwards into cap 104. This maintains both contact and pressure between cap ratchet wheel 402 and schedule-display ratchet wheel 208 when lugs 406 move around cam surfaces 224 of boss features 220 and 902, and cap 104 starts to move up and away from cylindrical container 102. Finally, as shown in FIG. 9H, the lugs 406 fully disengage from the boss features 220 and reside in the spaces 904 between successive boss features 220 allowing the cap to be vertically pulled away from the container. During the entire sequence of steps shown in FIGS. 9F-H, the schedule display is affixed in position with respect to the cap as a result of intermeshing of the cap ratchet wheel and the schedule-display ratchet wheel. Human-applied pressure on cap 104 forces cap ratchet wheel 402 and schedule-display ratchet wheel 208 together, further increasing friction so that they will not slide past each other and do not slip a single position. The schedule display 202 is thus compelled to rotate counterclockwise in lock-step with cap 104.

In the example implementation cap and schedule-display ratchet wheels 402 and 208 form a biasing means in the counterclockwise direction. This function could also be provided by a variety of mechanisms connecting the top of the schedule display to the bottom of the cap, including prongs, pawls, or variety of projections, notches or grooves on one component and a complementary mechanism on the other. It is also conceivable that biasing means could be established anywhere between the outside of schedule display 202 and the inside of cap 104. For example, biasing means could be located between cylindrical cap rim 106 and display surface 206 and can utilize any of the aforementioned means. In the example implementation biasing features 502 are wedge-shaped projections. However, a variety of shapes with a side to engage the boss features in one direction and a side to slide over ramp portions 226 in the other direction can be used.

In the example implementation after cap 104 is removed from cylindrical container 102, compression in schedule display 202 created from mounting it inside cap 104 aids in increasing friction between cap ratchet wheel 402 and schedule-display ratchet wheel 208 to prevent the schedule display 202 from unintentionally advancing. However compression is not necessary for sufficient friction when cap ratchet wheel 402 and schedule-display ratchet wheel 208 are partially engaged. Alternatively, friction between the inner surface of the cylindrical cap rim 106 and the display surface 206 may also suffice.

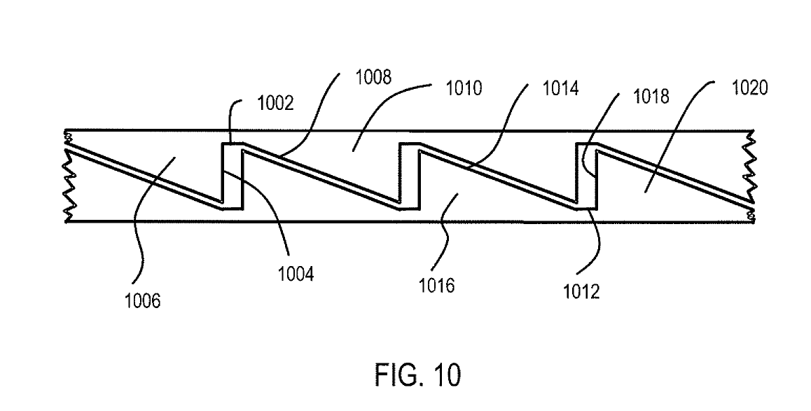

FIG. 10 shows an enlarged unwrapped view of an alternative implementation of the cap ratchet wheel and schedule-display ratchet wheel. In this alternative implementation, an additional horizontal edge 1002 separates the engaging side 1004 of a first cap-ratchet-wheel tooth 1006 from the sliding edge 1008 of a successive cap-ratchet-wheel tooth 1010 and, similarly, a short horizontal edge 1012 separates the sliding edge 1014 of each schedule-display ratchet-wheel tooth 1016 from the engaging side 1018 of a successive schedule-display ratchet-wheel tooth 1020. The purpose of the implementation shown in FIG. 10 is to provide an alternative method for altering common ratchet-wheel teeth so that cap 104 snaps into place via the schedule display 202 before lugs 406 reach stop portion 232 of boss features 220. This alternative implementation can replace ratchet wheels 402 and 208 in the example implementation or any modified implementation described in this document. In this alternative implementation, the ratchet-wheel teeth are shortened so that they are not contiguous, creating spaces along bases of the cap ratchet wheel and schedule-display ratchet wheel. When cap 104 is placed on cylindrical container 102 and rotated clockwise for the purpose of mounting the cap to the cylindrical container, the ratchet-wheel tips slip past one another before the leading sides 408 of lugs 406 reach stop portions 232 of boss features 220.

Grips 512 and 514 on the schedule display 202 enable a person to manually adjust which schedule element is visible through aperture 110. In the example implementation, grips 512 and 514 together compose a pair of raised tabs that can be engaged by fingers. However, a single tab as well as a variety of protrusions, indentations, and or holes can provide the same function in alternative implementations. These features can either be part of, or connected to, the underside of disk-shaped portion 212 of the schedule display 202, the inner side of the cylindrical rim of the schedule display, or connected to both.

One feature of the design of the example implementation of the medicine dispenser is that the display surface 206 provides a space to print, imprint, emboss, deboss or adhere schedule elements, because the display surface provides sufficient space on schedule display 202 for large characters and symbols. Furthermore the height of the display surface 206 can be extended along with cylindrical cap rim 106 to accommodate even larger characters and symbols without widening cylindrical container 102.

In alternative implementations, the schedule is instead located on the disc portion of the schedule display and the aperture is located on the top surface of the cap. In yet additional alternative implementations, the schedule elements are visible and the aperture is replaced with an indicator or arrow which designates or points to an individual schedule element. The placement of the indicator and schedule elements can be swapped so that the schedule elements are on the cap and the indicator is on the schedule display in certain implementations.

Implementations of the medicine dispenser do not require spring tension or bending of components which are likely to be manufactured out of plastic, nor do they require the use of spring fingers or other types of narrow extensions prone to wear and breakage. Furthermore, implementations of the medicine dispenser function without overly stressing any of the three components, facilitating the reduction and/or elimination of wear. Therefore, implementations of the medicine dispenser achieve a higher level of durability for safe dispensing of prescription medications.

The next section more specifically describes attributes of the example implementation that allow the example implementation to advance precisely one schedule element at a time, realign for each next cycle, work automatically and flawlessly, prevent human error, incur little wear, continue to work with some wear, function when some of the components are manufactured imperfectly, and be calibrated to various numbers of schedule elements.

Component proportions, ratios between the numbers of various components, and alignment of various components contribute to the proper functioning of the example implementation. Components of the example implementation described in this section are proportioned to control the degrees of relative rotation between cap 104, schedule display 202, and cylindrical container 102. Therefore the length or proportion of various components as well as the spacing of various components is described in terms of the degrees of the central angle of their arc around the central axis of the example implementation rather than as a particular size or scale. The central axis is an imaginary vertical line through the center of the implementation. Lateral arcs are used to describe the rotational distance between two components that may differ in their vertical placement on the example implementation.

In the example implementation the central angle of the lateral arc from the leading edge 228 to the stop portion 232 of each boss feature 220 and the alignment of biasing features 502 with lugs 406 determines the number of degrees by which cap 104 rotates around schedule display 202 each time the cap is mounted to cylindrical container 102.

Cap ratchet wheel 402 is rotationally positioned relative to lugs 406 and schedule-display ratchet wheel 208 is rotationally positioned relative to biasing features 502 so that, when cap ratchet wheel 402 is fully meshed with schedule-display ratchet wheel 208, leading sides 408 of lugs 406 are vertically aligned with the abutment surfaces 506 of a portion of biasing features 502. When cap 104 is mounted onto cylindrical container 102 and rotated clockwise, abutment surfaces 506 of a portion of biasing features 502 contact leading edges 228 of boss features 220, preventing further rotation of the indicator while cap 104 continues to rotate until lugs 406 reach stop portions 232. Cap 104 thus rotates around schedule display 202 the same number of degrees as the lateral arc from the leading edge 228 to the stop portion 232 of each boss feature 220.

Boss features 220 are proportioned so that, when the cap 104 advances around the schedule display 202 through a predetermined number of mounting cycles, the cap rotates 360 degrees relative to schedule display 202 and re-centers aperture 110 over the starting schedule element. Aperture 110 on cap 104 is rotationally positioned relative to the cap ratchet wheel 402 on its underside and schedule elements are positioned around the display surface 206 relative to schedule-display ratchet wheel 208 so that when cap ratchet wheel 402 is meshed with schedule-display ratchet wheel 208, aperture 110 is centered over one schedule element 204.

The central angle of the lateral arc between the leading edge 228 and stop portion 232 of each boss feature 220 of the example implementation is a unit fraction (a fraction with numerator=1 and denominator=an integer) of 360 degrees. Therefore Cap 104 and thus aperture 110 advance a unit fraction of 360 degrees during each mounting cycle. When cap 104 is removed from and mounted onto cylindrical container 102 a number of times equal to the denominator of the unit fraction of the central angle between the leading edge 228 and the stop portion 232 of each boss feature 220, the cap advances around schedule display by 360 degrees.

The proportions of boss features 220 are coordinated with the desired number of schedule elements. Schedule elements are evenly spaced around the schedule display 202 in increments of 360 degrees divided by the number of schedule elements. In the example implementation, boss features 220 are proportioned so that the central angle of the lateral arc from the leading edge 228 to the stop portion 232 is also equal to 360 degrees divided by the number of schedule elements. Therefore in each mounting cycle, aperture 110 accurately advances from the center of one schedule element to the center of the next schedule element.

In the example implementation, the proportions of boss features 220 and the spacing and number of biasing features 502 also are coordinated so that, at the end of each mounting cycle, each of the relevant components is realigned and the device is ready for the next mounting cycle.

Biasing features 502 of the example implementation are spaced in degree increments around the schedule display 202 equal to the central angle of the lateral arc between leading edge 228 and stop portion 232 of each boss feature 220. This is also the number of degrees by which cap 104 rotates around the indicator during each cycle. When cap 104 is applied to cylindrical container 102 and rotated clockwise for mounting, the leading side 408 of each lug 406 starts in vertical alignment with abutment surface 506 of one biasing feature 502. With biasing features 502 so spaced, at the end of each cycle, each lug 406 on cap 104 rotates into the same relative vertical alignment with the next sequential biasing feature 502. Cap 104 and schedule display 202 thereby align for the next cycle.

The numbers of biasing features 502, lugs 406, and boss features 220 are also coordinated. Between cycles, each lug 406 is aligned relative to a biasing feature 502. During each cycle, lugs 406 advance to each align relative to their next sequential biasing feature 502. In future cycles, each lug 406 aligns relative to a biasing feature 502 previously aligned relative to preceding lugs. For this process to work indefinitely, the number of biasing features 502 is an integer multiple of the number of lugs 406.

The number of biasing features 502 in the example implementation is an integer multiple of the number of lugs 406. The number of lugs 406 is equal to the number of boss features 220. The number of biasing features 502 is therefore also an integer multiple of the number of boss features 220.

With each mounting cycle, aperture 110 rotates to center over the next schedule element 204 in the sequence of schedule elements while lugs 406 each rotate into alignment with the next sequential biasing feature 502. Schedule elements 204 and biasing features 502 are therefore spaced in equal degree increments around schedule display 202 and are therefore also equal in number. The number of schedule elements 204 is therefore also an integer multiple of the number of boss features 220 on cylindrical container 102.

The number of teeth 210 and 404 are also coordinated with the number of schedule elements 204 and biasing features 502 and the proportions of boss features 220. The number of teeth 210 and 404 are each an integer multiple of the number of schedule elements 204 and biasing features 502. At the beginning of each cycle, cap ratchet wheel 402 and schedule-display ratchet wheel 208 are fully meshed. Because the number of teeth are an integer multiple of the number of biasing features 502, when cap 104 advances through one cycle, cap ratchet wheel 402 and schedule-display ratchet wheel 208 rotate by a whole number of teeth so that they finish each cycle in the fully meshed position. Aperture 110 is then centered over one schedule element 204. Because they are in the fully meshed position, cap ratchet wheel 402 and schedule-display ratchet wheel 208 do not slip and rotate in relationship to each other when the cap 104 is rotated counterclockwise for the purpose of removing the cap from cylindrical container 102.

The example implementation has one tooth on each ratchet wheel per schedule element for the purpose of preventing human error. When more than one tooth per schedule element is present, a user feels a bump each time the tips of the ratchet-wheel teeth slip over one another. The feeling of teeth slipping over each other is often confused with the sensation of completing the process of mounting the cap when the lugs snap into the lug notches. The cap and schedule-display ratchet wheels 402 and 208 are rotationally positioned relative to cap 104 and schedule display 202 so that, when mounting cap 104 to cylindrical container 102, a person feels the cap and schedule-display ratchet wheels 402 and 208 slipping into place simultaneously with lugs 406 sliding into lug notches 230.

Furthermore, when a person attempts but fails to affix cap 104 properly and lugs 406 fail to slide all the way into lug notches 230, then teeth on the cap and schedule-display ratchet wheels 402 and 208 do not slip past each other, and cap 104 and aperture 110 do not inadvertently advance around schedule display 202. Furthermore, compression in the inner rim 702 of schedule display 202 pushing cap and schedule-display ratchet wheel 402 and 208 together will cause the teeth to settle back into their original positions, preventing an inadvertent indication. Therefore, cap 104 only makes an indication if the cap is successfully and completely mounted onto cylindrical container 102. It should be clear from this description that the example implementation functions automatically, accurately, and prevents human error. Furthermore, it should also be clear that no conscious human effort or control is needed for the example implementation to make its indications. Thus, unlike prior art, the example implementation is not prone to human error caused by failed attempts to adhere the cap to the cylindrical container.

The example implementation is also designed to make exactly one indication every time cap 104 is mounted onto cylindrical container 102 despite manufacturing imperfection and possible device wear. To ensure device accuracy despite these variations, the ratchet-wheel teeth in the example implementation are modified from common ratchet wheel-teeth. Common ratchet-wheel teeth are contiguous and the engaging side of each tooth is either 90 degrees with respect to its base or is slanted away from its sliding side. In the example implementation of the medicine dispenser, engaging sides 805 of the ratchet-wheel teeth are slightly slanted towards the sliding sides 807. Because they are complementary, engaging sides 815 of the ratchet-wheel teeth are also slightly slanted toward sliding sides 817. More precisely, the inside angle between engaging side 805 and base 808 as well as the inside angle between engaging side 815 and base 808 is acute. This slant reduces the distance cap 104 needs to rotate around schedule display 202 to advance the tips of the ratchet-wheel teeth past one another while still maintaining a desired number of teeth.

When cap 104 is mounted onto cylindrical container 102, the ratchet wheel teeth tips pass one another and the cap 104 snaps into position with schedule display 202 momentarily before lugs 406 reach stop portions 232 of boss features 220 and pull into lug notches 230. Sequentially advancing the motion of cap 104 snapping into position with schedule display 202 before lugs 406 snap into lug notches 230 reduces the precision required to ensure the example implementation correctly displays the next schedule element. This enables the medicine dispenser to function properly despite a range of user and manufacturing variations as well as potential wear from use.

The difference in timing between cap ratchet wheel 402 on cap 104 snapping into place with schedule-display ratchet wheel 208 on schedule display 202 and lugs 406 snapping into place with lug notches 230 on cylindrical container 102 is sufficiently slight so that it is imperceptible to a common user. The example implementation therefore maintains a desired and familiar tactile experience by which a user feels one click when mounting cap 104 to cylindrical container 102.

The time interval between the above-mentioned events is sufficiently short so that, while mounting cap 104 to cylindrical container 102, it is not generally possible for a common person to advance the ratchet-wheel teeth on the cap and schedule-display ratchet wheels 402 and 208 without completing the motion of rotating lugs 406 all the way to stop portion 232 of boss features 220, completing the cycle. The example implementation therefore also maintains the desired property of advancing the displayed schedule element only when cap 104 is properly mounted onto cylindrical container 102. Furthermore, the slant on engaging sides 805 and 815 of the ratchet-wheel teeth is sufficiently slight so as not to interfere with their locking function when the cap 104 is rotated counterclockwise and removed from cylindrical container 102.

The mechanism utilized by the example implementation to make indications is also designed to conform to most common prescription drug regimens. Most prescriptions require the consumption of an exact number of pills each day. To help a user adhere to a daily schedule, the medicine dispenser should have one schedule element for each dose for each day of the week. The number of required schedule elements is therefore most often a multiple of seven days of the week.

The number of schedule elements 204 is an integer multiple of the number of boss features 220 on cylindrical container 102. Accordingly, the example implementation is designed with seven boss features 220 and fourteen schedule elements 204. The central angle of the lateral arc from the leading edge 228 to stop portion 232 of each boss feature 220 is one-fourteenth of 360 degrees. Thus, cap 104 advances one-fourteenth of the way around schedule display 202 in each cycle. Schedule display 202 shown in FIG. 5 has schedule elements 204 calibrated for two doses per day, one for AM and a second for PM for each day of the week. An alternative implementation calibrated for one dose per day would have the same number of boss features 220, lugs 406, ratchet-wheel teeth, and schedule elements. However, the schedule elements would consist of two sequential seven day sequences each with one schedule element for each day of the week.

The mechanism utilized by the example implementation is designed so that the dimensions of boss features 220 and the coordinated number of biasing features 502, ratchet-wheel teeth, and schedule elements 204 can be calibrated to accommodate other daily prescription schedules. For example, another implementation designed for three doses per day has 7 boss features and 21 schedule elements, one for each of the three doses for each day of the week. The boss features are proportioned so that the central angle of the lateral arc from the leading edge to the stop portion of each boss feature are 360 degrees divided by 21. To conform to schedules that are not correlated to seven days of the week, an alternative implementation may be created with a different number of boss features. For example, a cylindrical container with 6 boss features is calibrated to hourly and monthly schedules since hours of the day and months of the year are both multiples of 6.

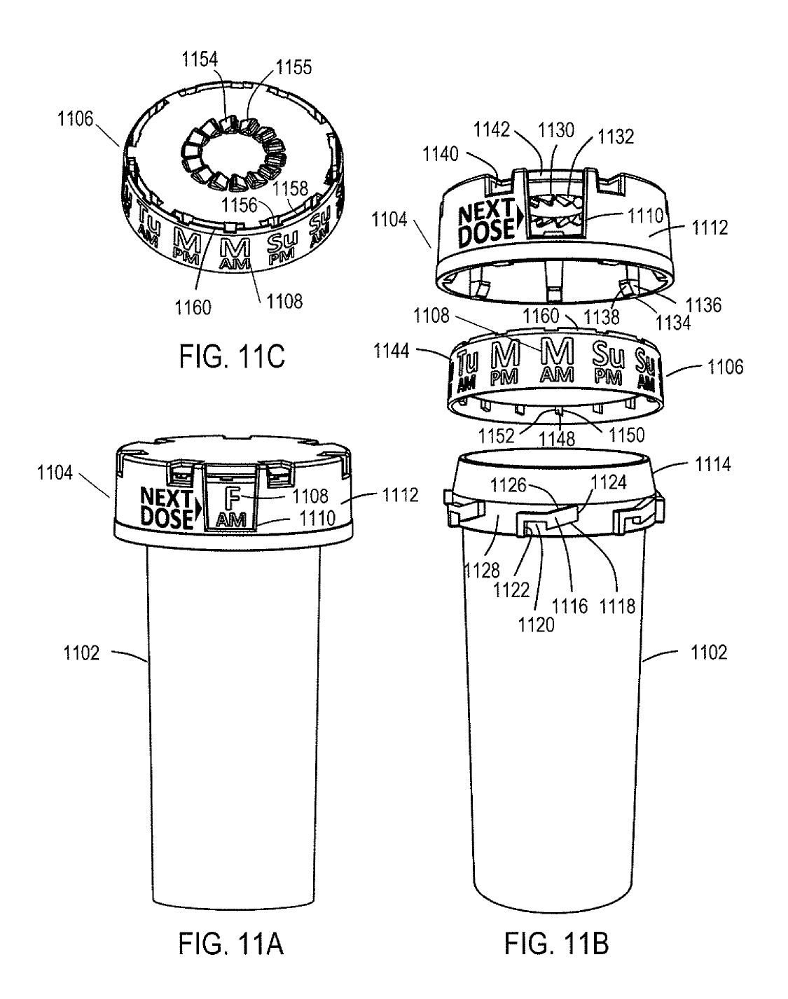

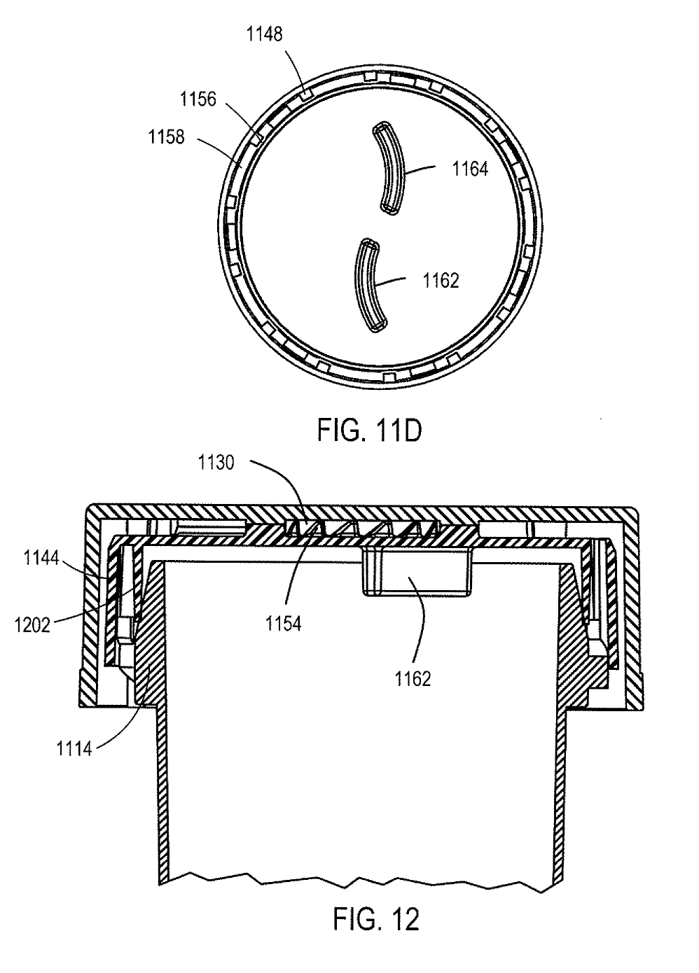

FIGS. 11A-D illustrate a second example implementation of the medicine dispenser. FIG. 11A shows a perspective view of the second implementation. FIG. 11 B shows an exploded view of the second implementation shown in FIG. 11A. The second implementation resembles the first example implementation shown in FIGS. 1-9, including a cylindrical container 1102 and a disk-shaped cap 1104 with an inner schedule-display component 1106. A single schedule element, or indication, 1108 is displayed to a user through an aperture 1110 in the cylindrical rim 1112 of the cap. Similar to the first implementation, the indication displays the day of the week and time when a next dose is to be administered. The cylindrical container 1102 includes a tapered lip 1114 and seven boss features, such as boss feature 1116, uniformly spaced around the outer circumference of the container. Each boss feature 1116 features a cam surface 1118, a lug notch 1120, a stop portion 1122, a leading edge 1124, and a ramp portion 1126. There is a significant space 1128 between two successive boss features. Each of the three components, including the cap 1104, schedule display 1106, and cylindrical container 1102, is shaped so that it can be quickly released from a mold.

As shown in the second implementation, an external, top portion of the bottle is tapered towards the bottle lip. In addition, the internal wall of the bottle is tapered outward, towards the opening, at a slight draft angle. The schedule-display and cap rims are also tapered outward, towards their respective openings, at a similar draft angle. The taper of the top, external portion of the bottle towards the bottle lip provides for a springy, snug fit of the bottle into the cap assembly and a tight seal.

Similar to the first implementation, the cap 1104 further includes a ratchet wheel 1130 with fourteen ratchet teeth, such as ratchet tooth 1132. At the base of the cap rim, seven evenly placed lugs 1134 protrude inward in radial directions from the inner surface of the cap rim. Each lug features a leading side 1136 and a tapered side 1138. The upper portion of the cylindrical rim of the cap also includes a set of evenly spaced holes, such as hole 1140, directly above each lug 1134. A shield 1142 is at the top of the aperture 1110 and recessed from the cap rim. Schedule display 1106 includes fourteen biasing features, such as biasing feature 1148, that extend inward around the inner surface the cylindrical wall 1144. Each biasing feature includes an engaging side 1150 and a tapered sliding side 1152.

FIG. 11C shows an alternative perspective view of the schedule display shown in FIG. 11B. FIG. 11C reveals additional features, including schedule-display ratchet wheel 1154 with fourteen ratchet teeth, such as ratchet tooth 1155, which is complementary to cap ratchet wheel 1130. The disk-shaped portion of the schedule display includes a set of evenly spaced holes, such as hole 1156, each of which is located directly above each of biasing features 1148, as well as slits, such as slit 1158, that run between alternating pairs of holes. Schedule display 1106 also features a bevel 1160 around the top of cylindrical wall 1144. FIG. 11D shows an enlarged bottom view of the schedule display 1106 revealing grips 1162 and 1164, similar to the grips 512 and 514 shown in FIG. 5, which allow for manual advancement of the schedule display.

The tapered side 1138 of lugs 1134 in the cap as well as slits 1158 and bevel 1160 of the schedule display are created to facilitate assembly of the cap and the schedule display. When the schedule display is placed underneath the cap for insertion, the lugs 1134 with tapered sides 1138 and the bevel 1160 center the scheduled display and reduce the force required for the schedule display to slide into the cap. Slits 1158 allows schedule-display cylindrical wall 1144 to compress to further reduce the force required for insertion and to prevent damage to either component. In addition, the shape of cap and schedule-display ratchet teeth also facilitates assembly of the cap and the schedule display. The tips of the ratchet teeth are rounded, instead of pointed, such that when the two ratchet wheels 1130 and 1154 are pressed together, the tips of the teeth slip over one another and intermesh.

FIG. 12 shows a cross-section view of the second implementation shown in FIGS. 11A-D. FIG. 12 includes numeric labels used above in FIGS. 11A-D and shows the relative placement of each of the various features shown in FIGS. 11A-D. The cross-sectional view illustrates the medicine dispenser when the cap is firmly attached to the container. FIG. 12 reveals an additional feature of the schedule display. As shown in the cross-sectional view, the schedule display features a raised inner rim 1202 that presses against the taped lip 1114 of the cylindrical container 1102. The pressure applied by the tapered lip 1114 to the inner rim 1202 forces the schedule-display ratchet wheel 1154 to fully mesh together with the complementary cap ratchet wheel 1130, locking the position of the schedule display with respect to the cap as well as providing an airtight and moisture-impermeable seal and springy resilience to pull the lugs into the lug notches for the purpose of securing the cap in a child-resistant manner.

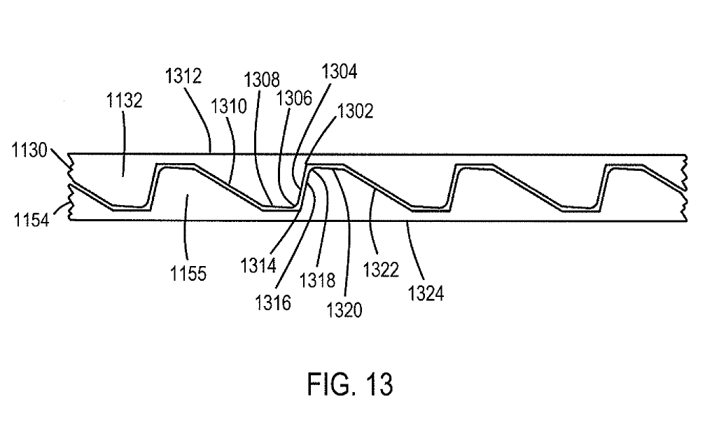

FIG. 13 shows an enlarged unwrapped view of a portion of the cap ratchet wheel and the schedule-display ratchet wheel of the second implementation shown in FIGS. 11A-D. Each of the cap ratchet teeth 1132 includes a leading end 1302, an engaging side 1304, a tip 1306, a sliding-side shallow portion 1308, a sliding-side steep portion 1310, and a base 1312. Similarly, the schedule-display ratchet wheel 1154 includes a series of 14 teeth, such as tooth 1155, each of which also includes a leading end 1314, an engaging side 1316, a tip 1318, a sliding-side shallow portion 1320, a sliding-side steep portion 1322, and a base 1324. Note that the tips 1306 and 1318 are moved back from leading ends 1302 and 1314. As a result, the engaging sides 1304 and 1316 of the cap and schedule-display ratchet teeth are slanted slightly towards the sliding sides such that the inside angle between the engaging side 1304 and the base 1312 of the cap ratchet tooth 1132 and the inside angle between the engaging side 1316 and the base 1324 of the schedule-display ratchet tooth 1155 is acute.

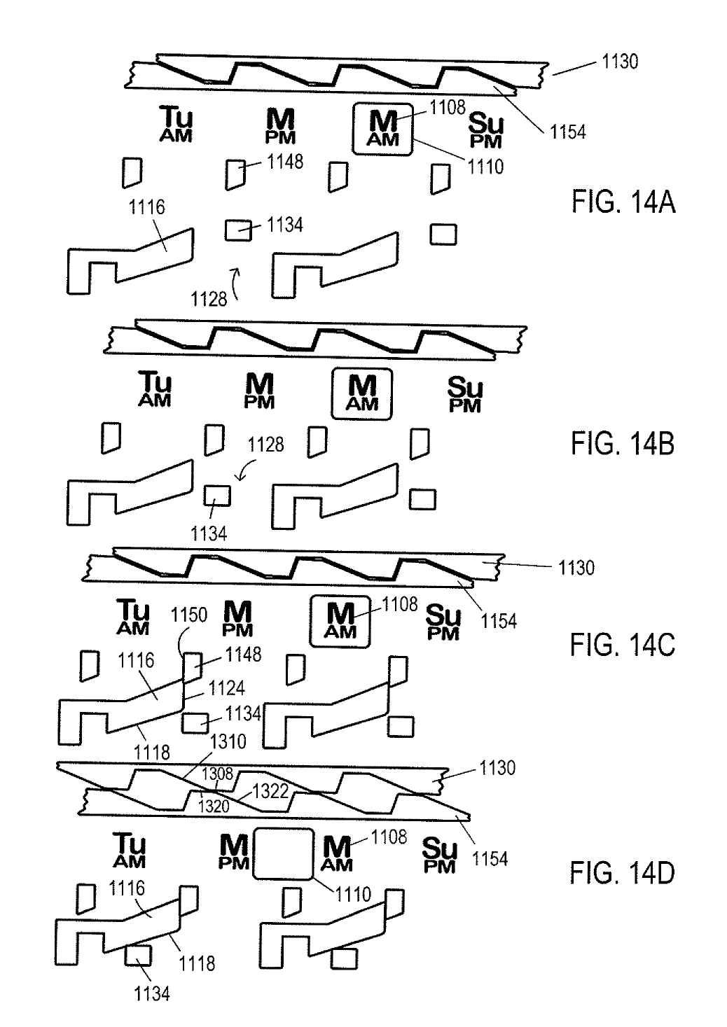

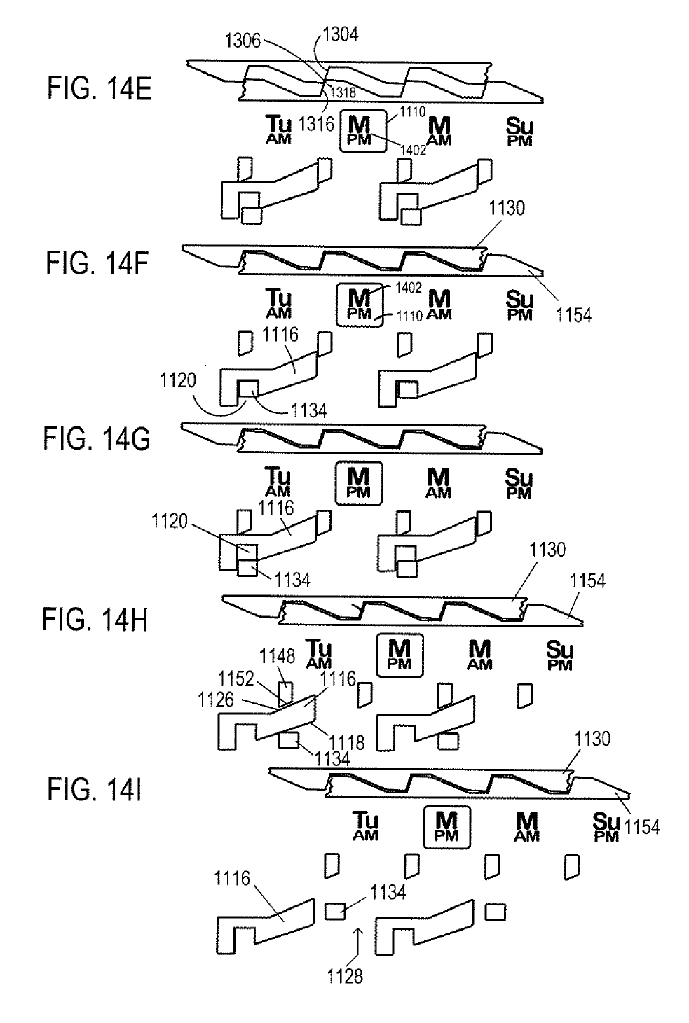

FIGS. 14 A-I provide unwrapped views of cap, schedule display, and container components of the second implementation shown in FIGS. 11A-D that illustrate step-by-step interaction of these components as the cap is mounted onto and removed from the container. FIGS. 14A-I resemble FIGS. 9A-H of the first implementation. FIGS. 14A-F illustrate the process of mounting the cap to the cylindrical container and the interaction of the various features and components. FIGS. 14 G-I illustrate the interaction of the various features and components as the cap is removed from the container. Mounting and removing the second implementation of the cap-and-schedule-display assembly to and from the container 1102 is similar to mounting and removing the first implementation of the cap-and-schedule-display assembly to and from the container 102 in FIG. 1. As shown in FIG. 14 A, prior to mounting the cap assembly onto the container, the cap ratchet wheel 1130 and schedule-display ratchet wheel 1154 are meshed together, fixing the position of the schedule display with respect to the cap. Cap lugs 1134 are in alignment with biasing features 1148. When the cap assembly is placed onto the container, pressed down, and rotated, lugs 1134 slip into the spaces 1128 between two neighboring boss features, as shown in FIG. 14B. In FIGS. 14C-D, when the cap assembly is rotated in a clockwise direction for the purpose of mounting it to the container, the engaging side 1150 of biasing feature 1148 comes into contact with the leading edge 1124 of boss feature 1116, preventing schedule display 1106 from rotating with the cap while the lug 1134 continues to rotate along the cam surface 1118 of the boss feature 1116. Cap ratchet wheel 1130 and schedule-display ratchet wheel 1154 slip over each other in the disengaged direction. As the cap 1104 rotates around the schedule display 1106 and the container 1102, aperture 1110 moves from one schedule element to the next in FIG. 14 E.

It should be noted that the sliding side of the cap and schedule-display ratchet teeth has a steep portion near the base and a shallow portion near the top. As the contact area between the cap and schedule-display ratchet teeth transitions from the steep portions 1310 and 1322 to the shallow portions 1308 and 1320, friction diminishes and mechanical advantage improves. This encourages a user to continue to rotate the cap until a mounting cycle is completed. Therefore, when a user applies sufficient torque to initiate the mounting process, the torque applied at the initiation of the mounting process is generally sufficient to carry through the mounting cycle until the next schedule element is reached.

In FIG. 14E, aperture 1110 is almost centered over the next sequential schedule element 1402. Tips 1306 of cap ratchet wheel 1130 have reached tips 1318 of schedule-display ratchet wheel 1154. Note that the engaging sides 1304 and 1316 of the ratchet teeth are slanted and that the slant reduces the rotational distance the ratchet wheel tips need to travel to pass one another in order that the teeth reach their next position before aperture 1110 is centered over the next indication. The slant ensures that the aperture reliably reaches a next intended indication despite limitations in manufacturing tolerances, potential wear from use, and variations in use. However, the engaging sides of the ratchet teeth are not sufficiently slanted that they prevent the ratchet teeth from providing sufficient biasing when rotated in the engaging direction. The shape of the ratchet teeth allows for the number of teeth equal to the number of indications such that the cap advances precisely one tooth in each mounting cycle and is therefore rotationally realigned for the next cycle.

In FIG. 14F, the lugs 1134 slip into the lug notches 1120 of the boss features 1116 as the teeth of the cap ratchet wheel 1130 interlock again with the teeth of the schedule-display ratchet wheel 1154 advanced clockwise by one tooth with respect to the schedule-display ratchet wheel. Aperture 1110 is now centered over the next sequential indication 1402.

When the cap is pushed down into the container, as shown in FIG. 14G, the downward pressure applied to the cap forces the lugs 1134 to disengage from the lug notches 1120 of the boss features 1116. When the cap with the schedule display is rotated counter-clockwise for removal, as shown in FIG. 14H, each lug 1134 travels along the cam surface 1118 of each boss feature 1116 while the sliding surface 1152 of each biasing feature 1148 slides along the ramp portion 1126 of the boss feature. The schedule display does not rotate with respect to the cap as a result of intermeshing of the cap ratchet wheel 1130 and the schedule-display ratchet wheel 1154 during the entire sequence of steps shown in FIGS. 14 G-I. Finally, as shown in FIG. 14I, the lugs 1134 fully disengage from the boss features 1116 and reside in the spaces 1128 between successive boss features, allowing the cap assembly to be vertically pulled away from the container.

It should be noted that proportions and positions of various components and features, ratios between the numbers of various components and features, and alignment of various components and features are the same as previously described with reference to the first implementation. The number of ratchet teeth of cap ratchet wheel 1130 and the complementary schedule-display ratchet wheel 1154 is an integer multiple of the number of schedule elements 1108. The number of schedule elements 1108 is equal to the number of biasing features 1148 which is an integer multiple of the number of lugs 1134 and boss features 1116. The central angle of the lateral arc from the leading edge 1124 to the stop portion 1122 of each boss feature 1116 is equal to the central angle from one indication 1108 to a next indication and is also equal to the central angle from one ratchet tooth to a next tooth. As previously discussed with reference to the first implementation, the proportions, number, and spacing of various features and components allow the device to start and stop each cycle with the same rotational alignment between features such that the device works in perpetuity and rotates exactly 360 degrees back to its original position.

The medicine dispenser can be set to a desired initial indication or rotationally adjusted to a particular indication during use. When the cap with the schedule display is removed from the container, a user can apply pressure to grips to rotate the schedule display with respect to the cap to a particular indication. Alternatively, a user can ratchet the cap assembly back and forth when the cap assembly is mounted onto the container. In the counter-clockwise motion, a set of biasing features slide up boss ramp portions and slide past the boss features. In the returning clockwise motion, the set of biasing features re-engage with the leading edges of the boss features and the indication is advanced to the next one as the motion is completed. This counter-clockwise and clockwise rotation can be repeated until a desired indication is reached.

Various previously-mentioned features and particular attributes enable rapid and cost effective manufacture and assembly of the medicine-dispenser implementation shown in FIGS. 11A-D. For example, holes 1140 in the cap allow for effective manufacture of lugs 1134. Because the lugs 1134 extend under the schedule display to engage with the container, compared to lugs on a conventional cap, the lugs 1134 shown in the second implementation of the medicine dispenser are slightly lengthened to extend over the open cavity of the cap. The mold for a generally cylindrical and closed-end cap includes a side that fills the void on the inside of the cap. Once the mold is filled with plastic, it separates into two pieces to release the new part inside. The first half of the mold that fills the cavity of the inside of the cap pulls out from a second half that creates a cavity around it to create a void in the shape of the cylindrical wall and closed end of the cap. However, a portion of the cap cavity is below the lugs, which could hinder separation of the first half of the mold from the second half of the mold, as the first half that fills the cavity pulls out from under the lugs. Holes 1140 in the cap enable the second half of the mold to fill the void directly under the lugs. When the mold separates, the portion of the second half of the mold that fills the portion of the cap cavity under the lugs can release through holes 1140. Holes 1156 in the schedule display work in the same manner as holes 1140 in the cap, thus allowing a two-piece mold to create biasing features 1148 that extend around the inner wall of the schedule display.

The shape of cap aperture 1110 is also created for rapid and cost effective manufacture. While the aperture is a cavity, in a mold the aperture is a protrusion. A protrusion can affect the rapid release of a two-piece mold. As the mold is separated, a protrusion would pull through the plastic wall of the cap. To improve manufacturing efficiency and speed, the aperture extends through the top surface of the cap. The protrusion in the mold therefore does not pull through the cap wall because there is no wall in the direction the mold releases. Further, the aperture tapers outward towards the top. The protrusion in the mold therefore has a wedge shape that readily releases from the plastic that forms the cylindrical rim of the cap.

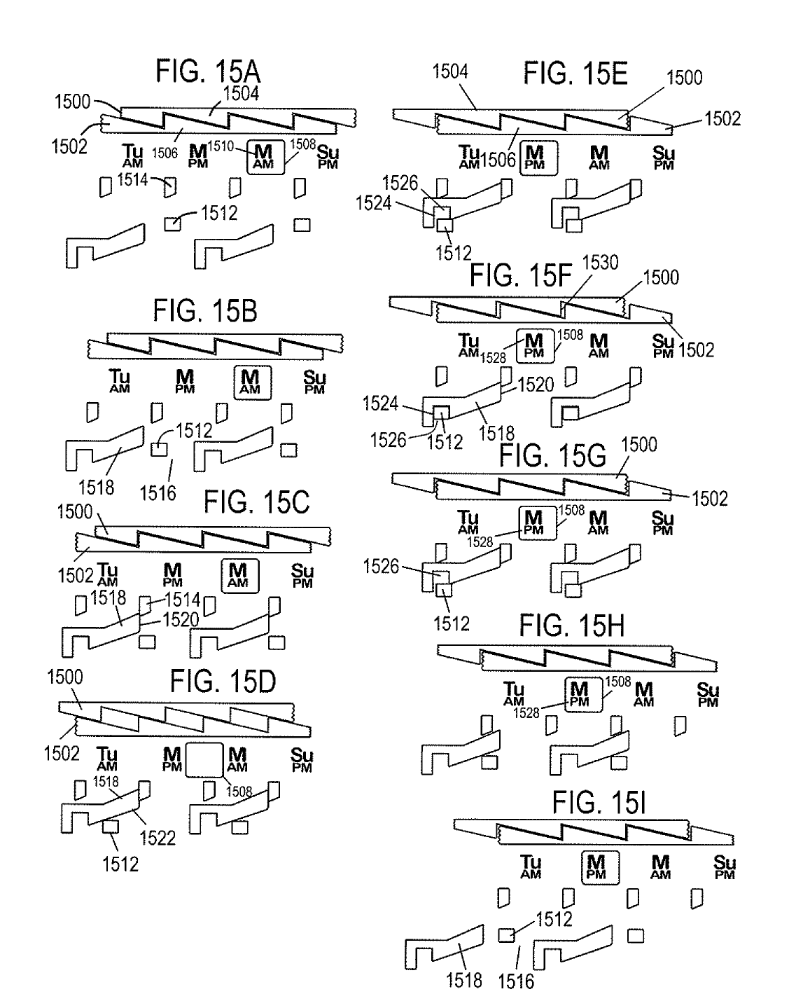

FIGS. 15 A-I provide unwrapped views of cap, schedule display, and container components of a third implementation that illustrate step-by-step interaction of various components as the cap is mounted onto, and removed from, the container. FIGS. 15 A-I resemble FIGS. 9A-H of the first implementation. FIGS. 15 A-F illustrate the process of mounting the cap to the cylindrical container and the interaction of various features and components. FIGS. 15 G-I illustrate the interaction of the various features and components as the cap is removed from the container. This implementation utilizes an alternative method to ensure that the device makes a precise indication in each mounting cycle despite limitations in manufacturing tolerances and possible wear.

The three components of the third implementation, including a cap, a schedule display, and a container, resemble the three components 104, 202, and 102 shown in the first implementation with reference to FIGS. 1-8. Mounting and removing the third implementation of the cap-and-schedule-display assembly to and from the container is similar to mounting and removing the first implementation of the cap-and-schedule-display assembly to and from the container 102 in FIG. 1.

As shown in FIG. 15A, the cap includes cap ratchet wheel 1500 with ratchet teeth, such as ratchet tooth 1504, intermeshing with the schedule-display ratchet wheel 1502 with ratchet teeth, such as ratchet tooth 1506, when the schedule display is inserted into the cap. An aperture 1508 in the cylindrical rim of the cap displays a single indication 1510 to a user. Cap lugs 1512 are in alignment with schedule-display biasing features 1514. In FIG. 15B, the cap-schedule-display assembly is placed onto the container for the purpose of mounting the cap-schedule-display assembly to the container and rotated clockwise. Lugs 1512 slip into the spaces 1516 between two successive boss features 1518. In FIG. 15C, when the cap-schedule-display assembly is rotated clockwise, biasing features 1514 make contact with the leading edge 1520 of the boss features 1518, preventing further rotation of the schedule display relative to the container. In FIG. 15D, as the cap continues to rotate around the container, cap ratchet wheel 1500 slides over schedule-display ratchet wheel 1502 in the disengaged direction and aperture 1508 moves from one indication to the next, while lugs 1512 travel along the cam surface 1522 of the boss feature 1518. As shown in FIG. 15E, cap lugs 1512 have not reached the stop portion 1524 of lug notches 1526, yet the tips of ratchet teeth 1504 and 1506 have passed over one another and ratchet wheels 1500 and 1502 are intermeshed again. In FIG. 15F, lugs 1512 slide into lug notches 1526 and reach the stop portion 1524 of boss features 1518. The cap with the schedule display is mounted onto the container and the aperture 1508 is now centered over the next sequential indication 1528. Note that ratchet wheels 1500 and 1502 have continued to slide further, revealing gaps 1530 between the engaging sides of two engaging ratchet teeth. Thus, the central angle of the lateral arc from leading edges 1520 to stop portions 1524 of boss features 1518 is greater than the central angle from one indication to the next and the central angle from one ratchet tooth to the next. As a result, the tips of cap ratchet teeth rotate further past the tips of schedule-display ratchet teeth, ensuring that the cap only makes an indication if the cap is completely mounted onto the container.

To remove the cap with the schedule display from the container, as shown in FIGS. 15G-H, a user applies pressure to the cap such that lugs 1512 disengage from the lug notches 1526. When the cap with the schedule display is rotated counter-clockwise for removal, as the ratchet wheels 1500 and 1502 slip backwards to close gaps 1530, aperture 1508 rotates slightly off the perfectly centered position above the indication 1528 until the engaging sides of the ratchet teeth make contact, fixing the position of the schedule display relative to the cap. As the cap-schedule-display assembly continues to rotate, lugs 1512 fully disengage from the boss features and slide into the spaces 1516 between two successive boss features, allowing the cap assembly to be pulled up from the container.

In the third implementation shown in FIGS. 15A-I, because the central angle of the lateral arc along which the aperture travels from one indication to the next is greater than the central angle of the lateral arc between two successive ratchet teeth, the aperture starts slightly off-center from the indication and re-centers over the next indication when the cap is remounted. The position of the aperture in the cylindrical rim of the cap may be rotationally adjusted so that the discrepancy from the center position can be ameliorated.

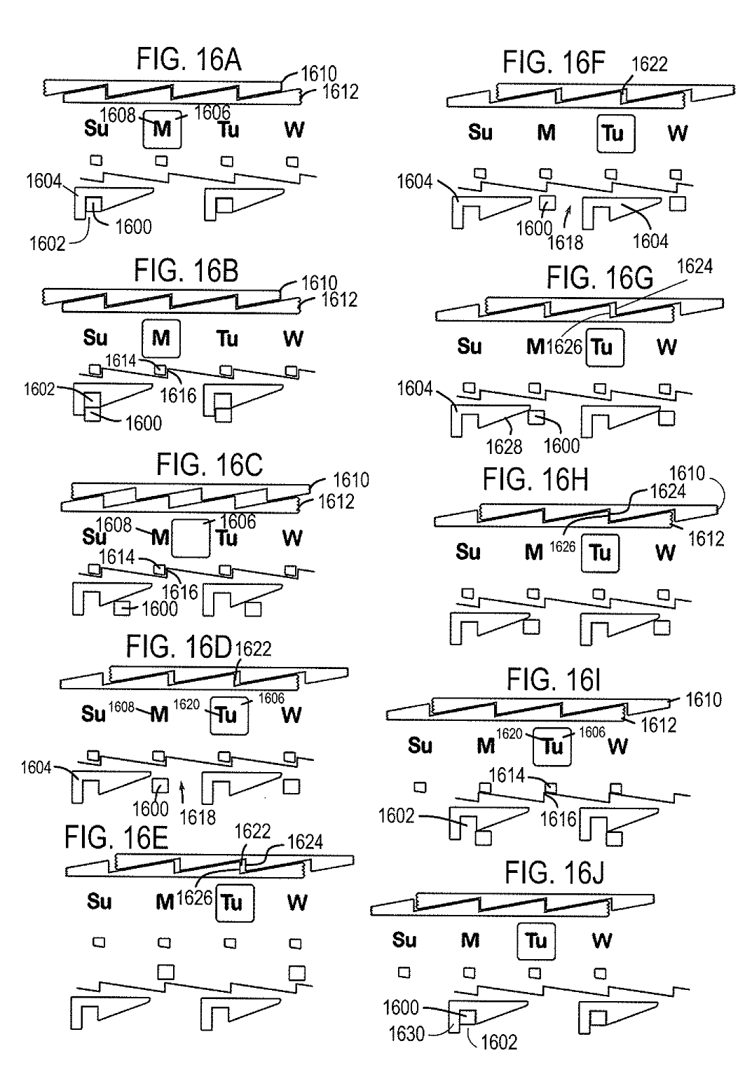

FIGS. 16A-J provide unwrapped views of cap, schedule display, and container components of a fourth implementation that illustrate step-by-step interaction of various components and features as the cap is removed from, and remounted onto, the container. FIGS. 16A-E illustrate the interaction of various features and components as the cap-schedule-display assembly is removed from the container. FIGS. 16F-J illustrate the interaction of the various features and components as the cap-schedule-display assembly is remounted onto the container. This implementation also resembles the third implementation shown in FIGS. 15A-I. However, the fourth implementation shown in FIGS. 16A-E makes an indication each time when the cap-schedule-display assembly is removed from the container.

The feature and components of the fourth implementation also resemble the features and components shown in the third implementation with reference to FIGS. 15A-I. In FIG. 16A, the cap-schedule-display assembly is mounted onto the container. Cap lugs 1600 are secured in lug notches 1602 of boss features 1604. Cap aperture 1606 is centered over the starting indication 1608 in the schedule display. Cap ratchet wheel 1610 and schedule-display ratchet wheel 1612 are fully meshed. FIGS. 16 B-E illustrate the process of removing the cap assembly from the container. In FIG. 16B, a user applies pressure to the cap to free lugs 1600 from lug notches 1602, while biasing features 1614 engage bottle biasing means 1616. In FIG. 16C, the cap is rotated relative to the container for removal. The engagement between biasing features 1614 and bottle biasing means 1616 prevents the schedule display from rotating with the cap. Thus, the cap rotates with respect to the schedule display and the cap aperture 1606 advances from the initial indication 1608 to the next indication. Cap ratchet wheel 1610 slides over schedule-display ratchet wheel 1612 in the disengaged direction. In FIG. 16D, lugs 1600 are released from boss features 1604 and slip into spaces 1618 between two successive boss features so that the cap-schedule-display assembly can now be removed from the container. The cap aperture 1606 reaches the next indication 1620. Note that, similar to the third implementation shown in FIGS. 15 A-I, the central angle of the lateral arc along which the cap travels during the removal process is greater than the central angle of the lateral arc from one ratchet tooth to the next, so that the tips of cap ratchet wheel teeth rotate further past the tips of schedule-display ratchet teeth, ensuring that the ratchet wheels reach the next engaged position and the device functions properly despite manufacturing imperfection. The further advancement of the ratchet wheels reveals a gap 1622 between two engaging ratchet teeth. In FIG. 16E, the cap-schedule-display assembly is removed from the container.

FIGS. 16F-J demonstrate the process of re-mounting the cap-schedule-display assembly to the container. In FIG. 16F, the cap-schedule-display assembly is pressed onto the container and rotated clockwise. Lugs 1600 slide into the space 1618 between two successive boss features. In FIGS. 16G-H, as the cap is rotated for the purpose of mounting it to the container, lugs 1600 travel along the cam surface 1628 of the boss features. The cap rotates around the schedule display until the engaging side 1624 and 1626 of ratchet wheel teeth make contact, so that the ratchet wheels are fully engaged and the schedule display is compelled to rotate in cooperation with the cap. In FIG. 16I, as the cap continues to rotate onto the bottle, schedule-display biasing features 1614 slide along bottle biasing means 1616 in the disengaged direction. Aperture 1606 remains centered over indication 1620. In FIG. 16J, lugs 1600 reach the stop portion 1630 of lug notches 1602 and the cap-schedule-display assembly is remounted onto the container.

Similar to the third implementation shown in FIGS. 15 A-I, the rotational position of the aperture can be adjusted so that the aperture is perfectly centered when the cap-schedule-display assembly is on and slightly off-center when the cap-schedule-display assembly is off. Alternatively, the position of the aperture can be adjusted so that the aperture is perfectly centered when the cap-assembly-display assembly is off. The aperture may also be positioned so that the different between the two positions can be split. The extra distance the cap rotates is sufficiently insignificant that any aperture off-centering does not impact the clarity of device indications.

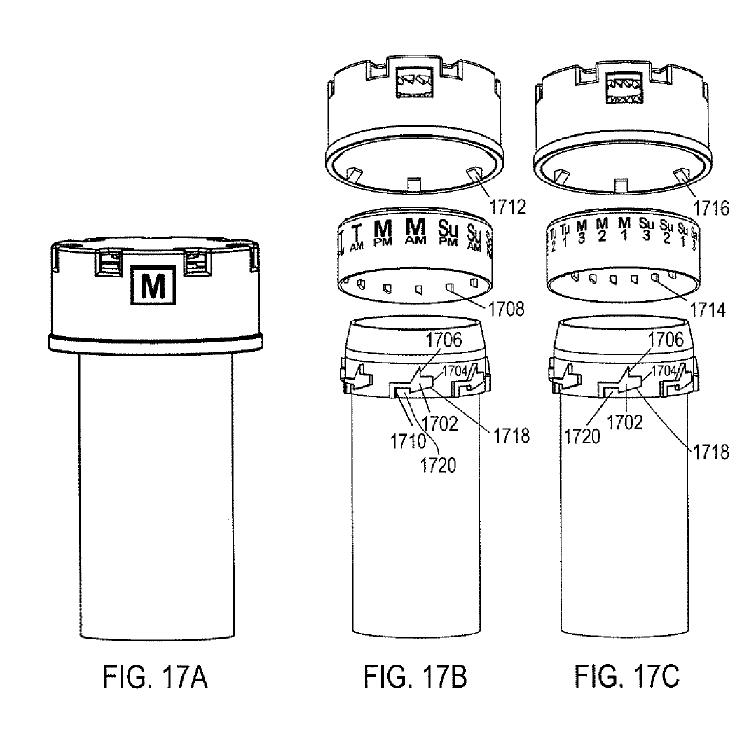

FIGS. 17A-C illustrate a fifth implementation of the medicine dispenser to which the medicine dispenser is directed. FIG. 17A shows a perspective view of a fifth implementation. FIG. 17B shows an exploded view of the fifth implementation shown in FIG. 17A. The fifth implementation resembles the second implementation shown in FIGS. 11A-D, with similar component features except that the boss feature 1702 in the fifth implementation includes a first leading edge 1704 and a second leading edge 1706 in addition to other features previously described. The indicating mechanism utilized by the fifth implementation is the same as that of the second implementation. The proportions of boss features 1702 are coordinated with the spacing and number of biasing features 1708 so that the rotational advancement of the cap around the schedule display during each mounting cycle is equal to the central angle of the lateral arc from the first leading edge 1704 to the stop portion 1710 of the boss feature. The first leading edge 1704 prevents further rotation of the schedule display with respect to the container by engaging with the biasing features 1708 of the schedule display, while the stop portion 1710 prevents further rotation of the cap with respect to the container by engaging with cap lugs 1712. This alternative implementation can replace boss features in any implementation previously described in this document.

Alternatively, the number of ratchet teeth of cap and schedule-display ratchet wheels and biasing features in the schedule display may be altered in order to provide for a different number of schedule elements. The proportions of boss features may also be altered to coordinate with the desired number of schedule elements. FIG. 17C shows an exploded view of an alternative implementation of the fifth implementation with twenty-one schedule elements. While the medicine-dispenser implementation shown in FIG. 17C shares the same bottle as the medicine-dispenser shown in FIG. 17B, the cap assembly includes 21 biasing features, 21 cap ratchet teeth, and 21 schedule-display ratchet teeth. In this implementation, biasing features 1714 are positioned vertically higher relative to the cap lugs 1716 than in FIG. 17B. When the cap with the schedule display is with respect to the container for the purpose of mounting the cap assembly to the container, the biasing features 1714 do not collide with the first leading edge 1704 of boss feature 1702, as in the implementation of FIG. 17B. Instead, cap lugs 1716 continue to slide along the cam surface 1718 of the boss feature 1702 and the schedule display continues to rotate with the cap until biasing feature 1714 collides with the second leading edge 1706 of the boss feature 1702, which prevents further rotation of the schedule display with respect to the container. The cap continues to rotate until lugs 1716 slip into lug notches 1720 of the boss features. The central angel of the lateral arc the cap advances is equal to the central angle from the second leading edge to the stop portion of the boss feature.

The central angle of the lateral arc from the first leading edge to the stop portion of each of the boss features and the central angle of the lateral arc from the second leading edge to the stop portion as well as the number of boss features is coordinated with the number and spacing of biasing features and schedule elements in different implementations. When the schedule display has 14 biasing features, 14 indications, and 14 ratchet teeth in each ratchet wheel, as shown in FIG. 17B, the central angle of the lateral arc from the first leading edge to the stop portion of each boss feature is equal to one-fourteenth of 360 degrees, which is also equal to the central angel the cap moves from one indication to the next, the central angel between two successive biasing features, and the central angel from one ratchet wheel tooth to the next. When the schedule display has 21 biasing features, 21 indications, and 21 ratchet teeth in each ratchet wheel, as shown in FIG. 17C, the central angel of the lateral arc from the second leading edge to the stop portion of each boss feature is equal to one-twenty-first of 360 degrees. As previously discussed in great detail with reference to the first implementation shown in FIGS. 1-9, the proportions and the number and spacing of various features and component are coordinated so that that, at the end of each mounting cycle, each of the relevant components is realigned and the device is ready for the next mounting cycle.

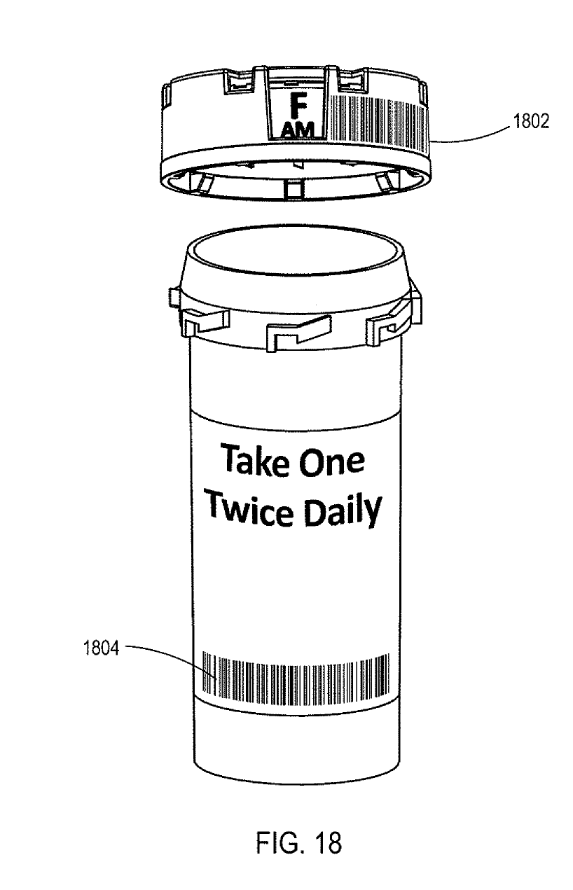

It is desirable that pharmacies can match each filled prescription bottle with a cap with a dispensing schedule that matches the prescribed dosing schedule. FIG. 18 illustrates a method of using a machine-readable code to improve pharmacy safety. A unique identifier, such as a barcode 1802 or other linear or matrix codes, is printed on the cap assembly of a medicine-dispenser and a matching code 1804 is printed on the bottle container of the medicine-dispenser so that a pharmacist or pharmacy technician can scan both codes with a barcode reading device to ensure that the cap assembly matches the bottle container. The unique identifier code is, in certain implementations, printed or embossed onto the exterior wall of the cylindrical rim of the cap or on the disk-shaped surface of the cap. The matching code is printed or embossed onto the exterior surface of the cylindrical wall of the bottle, the bottom surface of the bottle container, or any location visible to the pharmacist and accessible with a scanner, including a prescription label. The unique identifier may be a machine readable barcode, as shown in FIG. 18, or any other visually distinct symbols, marks, numbers, or colors that can be scanned visually or with a common code reading device.

Implementations of the medicine dispenser provide mechanical advantages over currently-available devices. First, implementations of the medicine dispenser can be effectively calibrated to any number of schedule elements that are a multiple of seven days of the week and can therefore conform to the most common prescription schedules. Implementations of the medicine dispenser also provide a means for manual adjustment to a correct indication. This is particularly helpful for presetting the indicator to a correct day and time of the first dosage. Implementations of the medicine dispenser include a commonly-accepted form of childproofing, are airtight and moisture-impermeable, and do not require a non-standard method of applying the cap to the cylindrical container.

The mechanism utilized by certain implementations of the medicine dispenser does not require conscious effort or control from a person for it to make accurate indications. And, the displayed schedule element is not advanced unless the cap is successfully mounted onto the cylindrical container, thus eliminating potential human error. Furthermore, the displayed schedule element advances one schedule element at a time and, at the end of each cycle, is automatically realigned for the next cycle.

Additionally, implementations of the medicine dispenser function without straining or bending any of components so that implementations of the medicine dispenser are less prone to usage wear. None of the components include thin plastic extensions that are likely to rapidly wear out or break. And, while implementations of the medicine dispenser do not incur undue wear, implementations of the medicine dispenser are also designed to function accurately despite some material wear, thereby further enhancing safety.

Each of the components of the example implementation can be rapidly mass-manufactured with simple molds. Each of the example implementations can be manufactured as just three pieces and can be made of the same materials from which common implementations of commercially-available pill bottles are manufactured. Additionally, the indicating mechanism utilized by the current implementations is designed to function properly despite potential variations in manufacturing accuracy.

Although the current disclosure has been described in terms of particular implementations, it is not intended that the invention be limited to these implementations. Modifications will be apparent to those skilled in the art. For example, as mentioned above, the number of ratchet-wheel teeth, biasing features, boss features, lugs, and schedule elements can be varied, in alternative implementations, in order to provide different numbers of schedule elements. In alternative implementations, a means for rotating the schedule display with respect to the cap in order to set an initial schedule display element may be used instead of the grips 512 and 514 discussed above with reference to FIG. 5. In certain implementations, features complementary to an initial-schedule-element setting tool can be used to ensure that the schedule is set by a pharmacist or other healthcare provider. As discussed above, the schedule elements contain various different types of information related to times, days of the week, dates, and other such characteristics that define when a next dose is to be administered. The schedule elements may be molded, embossed, printed, or otherwise placed onto the exterior wall of the schedule-display rim. The dimensions and shapes of each of the component features may vary with varying implementations provided that they interoperate together as described above. The cap, schedule display, and cylindrical container may be manufactured in any of many well-known polymeric materials, and can have essentially arbitrary colors, transparencies, rigidity and flexibility, and other such characteristics and parameters. The cylindrical container and cap may contain additional features, including additional information displays, features for facilitating attachment of additional information by pharmacies and pharmacists, and other features.

It is appreciated that the previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

1. A medicine dispenser consisting of:
an indicating cap comprising
a single-piece cap having a display aperture that displays a first indication, and
a single-piece schedule display, mounted within the cap, with multiple, circularly ordered indications that include the first indication; and
a single-piece container onto which the indicating cap is mounted, by downward pressure and rotation in a first direction, to seal the container and isolate the contents of the container from the environment external to the container,
the cap, schedule display, and container interoperating so that, during mounting of the indicating cap to the container, the cap rotates with respect to the schedule display by a rotation angle that results in the display aperture displaying a next indication, adjacent to the first indication, and so that, during removal of the indicating cap from the container, by rotation in a second direction with respect to the container, the cap does not rotate with respect to the schedule display.

2. The medicine dispenser of claim 1 wherein a portion of an external wall of the container is tapered inward towards a lip of the container.

3. The medicine dispenser of claim 2 wherein the container further includes a first number of boss features spaced around the outer circumference of the container below the portion of the external wall of the container that is tapered inward, each boss feature including a cam surface, a lug notch, a stop portion, and a leading edge.

4. The medicine dispenser of claim 1 wherein the cap further includes a ratchet wheel with ratchet teeth and multiple, evenly placed, inwardly protruding lugs on an inner surface of a rim of the cap.

5. A medicine dispenser consisting of:
an indicating cap comprising
a single-piece cap having a display aperture that displays a first indication, and
a single-piece schedule display, mounted within the cap, with multiple, circularly ordered indications that include the first indication; and
a single-piece container onto which the indicating cap is mounted, by downward pressure and rotation in a first direction, to seal the container and isolate the contents of the container from the environment external to the container,
the cap, schedule display, and container interoperating so that, during removal of the indicating cap from the container by rotation of the cap in a first direction with respect to the container, the cap does not rotate with respect to the schedule display and so that, during mounting of the indicating cap to the container, by rotation in a second direction with respect to the container, the cap rotates with respect to the schedule display by a rotation angle that results in the display aperture displaying a next indication, adjacent to the first indication.
